(19) United States
(12) Patent Application Publication
(10) Pub. No.: US 2014/0352648 A1
(43) Pub. Date: Dec. 4, 2014

(54) METHOD FOR DETERMINING A POSITION OF A PISTON IN A PISTON PRESSURE ACCUMULATOR BY RESISTANCE MEASUREMENT AND SUITABLY DESIGNED PISTON PRESSURE ACCUMULATOR

(71) Applicant: Robert Bosch GmbH, Stuttgart (DE)

(72) Inventors: Christoph Weisser, Gerlingen (DE); Thomas Becker, Esslingen/Zell (DE)

(73) Assignee: Robert Bosch GmmH, Stuttgart (DE)

(21) Appl. No.: 14/369,724

(22) PCT Filed: Dec. 27, 2012
(86) PCT No.: PCT/EP2012/076932

§ 371 Date: Jun. 30, 2014

(30) Foreign Application Priority Data
Dec. 28, 2011 (DE) 10 2011 090 048.9

(51) Int. Cl. G01M 15/06; F02F 3/00

(52) U.S. Cl. CPC G01M 15/06; F02F 3/00
USPC 123/193.6; 701/101

(57) ABSTRACT

The invention relates to a method for determining a position of a piston (5) in a piston pressure accumulator (1) and a ON correspondingly designed piston pressure accumulator (1). A housing (3) accommodates a displaceable piston (5). An electrode arrangement (15) having a plurality of 4-point measurement electrode pairs (17) is provided on the electrically conductive housing (3) and is designed to determine a position of the piston (5) inside the housing (3) by measuring a distribution of an electrical resistance or potential between inner electrodes (21) when a current is applied to outer electrodes (19), depending on a position along the housing (3). The position of the piston determined from the measurement of the potential distribution can be used to determine or check a charge state of the piston pressure accumulator (1).

### BACKGROUND OF THE INVENTION

The present invention relates to a method for determining a position of a piston within a piston pressure accumulator. The invention further relates to a method for checking an item of information relating to a state of charge of a piston pressure accumulator. The invention further relates to a suitably designed piston pressure accumulator, and also to a monitoring apparatus for monitoring a piston pressure accumulator.

Piston pressure accumulators are used for the purpose of mechanically storing energy. For example, piston pressure accumulators are used in hydraulic hybrid vehicles for the purpose of storing energy, which is generated during braking of wheels for example, and to make said energy available again, for example during subsequent acceleration of the vehicle.

In the case of a piston pressure accumulator, a, for example, cylindrical housing can contain a piston, which can be moved in said housing, as a separation element between two partial volumes of the piston pressure accumulator. A compressible fluid can be introduced into one of the partial volumes. A non-compressible fluid can be introduced into the other partial volume. In particular, the non-compressible fluid can be introduced into and discharged again from the corresponding partial volume by a suitable valve system in order to store and again release energy mechanically by compressing the compressible fluid.

DE 10 2010 001 200 A1 describes a conventional piston pressure accumulator.

In order to be able to determine a state of charge (SOC) of the piston pressure accumulator, that is to say in order to be able to determine how much energy is currently mechanically stored in the piston pressure accumulator, measurement variables which determine the energy content, such as the pressure prevailing in the piston pressure accumulator and the temperature prevailing in this case for example, can be measured. Pressure and temperature measurement of this kind is possible using simple sensors.

However, it has been observed that sometimes large inaccuracies can occur when determining the state of charge, in particular under dynamic operating conditions on account of, for example, a latency time of the temperature measurement.

As an alternative, the state of charge of a piston pressure accumulator can be ascertained on the basis of the current position of the piston within the housing of the piston pressure accumulator. The position of the piston can be ascertained, for example, by end position switches which ascertain the end position of the piston at one and/or the other end of the accumulator within the housing of the piston pressure accumulator, for example by means of a switching rod. As an alternative, the travel or location of the piston within the housing can be sensed, for example, by means of a piston rod, a cable-pull measurement system or an ultrasound travel measurement system.

However, systems of this kind for determining the current position of the piston require a high level of structural expenditure. In particular, it may be necessary to integrate components, such as end position switches or a piston rod for example, into the internal volume of the piston pressure accumulator, wherein it may be necessary to mechanically and/or electrically connect components of this kind to the outside.

### SUMMARY OF THE INVENTION

The method proposed in this document for determining a position of a piston within a piston pressure accumulator and also a correspondingly equipped piston pressure accumulator can allow the current position of the piston within the piston pressure accumulator to be determined with a high degree of accuracy and, despite this, a low level of structural expenditure.

In addition, an item of information relating to the state of charge of the piston pressure accumulator can be ascertained, and therefore an item of information, which is obtained in a different way, relating to said state of charge can be checked, on the basis of the position, which is determined in this way, of the piston within the piston pressure accumulator. The state of charge of the piston pressure accumulator can therefore be monitored in a more reliable manner.

According to a first aspect of the present invention, in a piston pressure accumulator which has a housing, which is preferably electrically conductive at least in subregions, and a piston, which can be moved within the housing and is likewise preferably electrically conductive at least in subregions, the current position of the piston within the piston pressure accumulator is determined by measuring a distribution of an electrical resistance along the housing.

To this end, an electric current can be locally induced in several positions in the region of the housing, and a resulting electrical potential distribution can then be locally determined. In this case, the current can be generated as direct current by applying a DC voltage between two electrodes. Similarly to in the case of electrical resistance tomography used in geophysics for displaying underground structures, the distribution of the electrical potential, as established on account of the induced current and on account of the electrical resistance which prevails between the two electrodes, can be determined, for example, using two further electrodes.

Since the position of the at least partially electrically conductive piston within the housing of the piston pressure accumulator has an influence on the electrical resistance which is measured across the housing or the electrical potential distribution which is established, an item of information relating to said position of the piston can be ascertained by determining said potential distribution.

According to one development of this measurement principle, an electric alternating current can be locally induced in several positions in the region of the housing. Said alternating current leads to a potential distribution across the housing of the piston pressure accumulator which varies over time. By virtue of local measurement of the resulting time-dependent electrical potential distribution, an even more accurate item of information relating to the current position of the piston within the housing of the piston pressure accumulator can be obtained in a similar way to in electrical impedance tomography.

In order to be able to execute the proposed method, a piston pressure accumulator can have an electrode arrangement on its housing, said electrode arrangement being designed to determine a distribution of the electrical resistance along the housing in order to be able to draw conclusions therefrom about the current position of the piston in the housing.

One advantage of the proposed position determination method or of a correspondingly designed piston pressure accumulator can be seen as that of no measurement sensors or other components needing to be arranged within the accumulator volume of the pressure piston accumulator. The distribution of the electrical resistance which is to be measured or of the electrical potential along the housing which is established on account of the induced electric current can be measured with the aid of electrodes which are fitted to the outside of the housing or can be integrated into a wall of the housing. External arrangement of the electrodes in this way can make it considerably easier to seal off the accumulator volume of the piston pressure accumulator.

In particular, the housing of the piston pressure accumulator can be formed from a fiber composite material. Piston pressure accumulators which are formed in this way can have a comparatively low weight together with a high level of mechanical stability. The fiber composite material can contain, for example, a carbon fiber woven fabric which is impregnated with a curing resin. Particularly in the case of carbon fiber composite materials (carbon fiber-reinforced plastics, CFRP), the housing of the piston pressure accumulator can have a high electrical conductivity on account of the electrical conductivity of the carbon fibers. Therefore, firstly, an electric current can be induced within the carbon fiber housing by fitting electrodes, and secondly a distribution of an electrical potential which is established thereafter can be determined by fitting further electrodes. A local electrical potential which is established will in this case depend on a position of the piston within the housing since the piston significantly changes the electrical resistance and the electrical conductivity in the region of the housing in which it is currently located on account of the inherent electrical conductivity of said piston and the fact that said piston is situated locally on the housing. In this case, the piston, like the housing, can be composed of an electrically conductive material or have an electrically conductive material of this kind at least on its surface which is directed toward the housing. The piston can be composed of metal for example.

Particularly when the housing of the piston pressure accumulator is designed with a fiber composite material, the electrode arrangement which is provided for measuring the distribution of the electrical potential can be integrated directly into the fiber composite material. In other words, electrodes can be integrated into a wall which is formed by the housing and surrounds the pressure accumulator volumes.

For example, when producing the housing with a carbon fiber composite material, directly corresponding electrodes can be implemented in the housing, for example in the form of metal wires with which contact can be made from outside the housing. Integration of electrodes into the fiber composite material in this way can allow both simple production of the housing of the piston pressure accumulator and also a reliable way of determining the position of the piston within the pressure accumulator with the aid of the integrated electrode arrangement.

The electrode arrangement which is provided on the housing of the piston pressure accumulator can have one or a plurality of 4-point measurement electrode pairs. In this case, each 4-point measurement electrode pair can have two electrodes for inducing the electric current and two electrodes for measuring the distribution of the electrical potential between the electrodes. The 4-point measurement electrode pairs can be arranged along the movement direction of the piston on the housing.

With the aid of the plurality of 4-point measurement electrode pairs, it is therefore possible in each case to determine a distribution of an electrical resistance or of an electrical potential in a subregion of the housing of the piston pressure accumulator along the movement path of the piston within the housing. Conclusions can therefore be drawn about a current position of the piston by simultaneous or successive measurement of the electrical potential at all 4-point measurement electrode pairs.

In this case, a distance between 4-point measurement electrode pairs which are adjacent along the movement direction of the piston can preferably be smaller than a length of the piston in a direction parallel to said movement direction.

A small spacing of adjacent 4-point measurement electrode pairs of this kind can lead to the piston for any desired position which can be assumed being adjacent to at least one of the 4-point measurement electrode pairs. The respective adjacent 4-point measurement electrode pair will identify, on account of the piston, a big change in the measured electrical potential between two electrodes of the 4-point measurement electrode pair, as a result of which a conclusion can be drawn about the presence of the piston in the vicinity of this position.

The above-described method for determining a position of the piston within a piston pressure accumulator can advantageously be used in order to determine or to check an item of information relating to the state of charge of the piston pressure accumulator on the basis of the determined position of the piston. A method of this kind can be executed in a monitoring apparatus for monitoring the piston pressure accumulator.

By way of example, during normal operation of the piston pressure accumulator, the state of charge of said piston pressure accumulator can be determined only on account of other measurement variables, such as a pressure and a temperature of the fluid which is stored in the piston pressure accumulator for example. The state of charge can be determined in a simple manner and with a generally sufficient degree of reliability on the basis of measurement variables of this kind which are simple to ascertain. However, in certain time intervals or, for example, under specific operating conditions of the piston pressure accumulator, it may be advantageous to monitor or to calibrate the state of charge measurement which is carried out in this way by additionally ascertaining an item of information relating to the current position of the piston within the piston pressure accumulator. This additional information allows more accurate determination of the state of charge of the piston pressure accumulator and/or allows the plausibility of the state of charge which is ascertained with other measurement methods to be checked.

It should be noted that possible features and advantages of embodiments of the invention are described in this document partially with reference to the method for determining the position of the piston within the piston pressure accumulator, partially with reference to the method for checking the information relating to the state of charge of the piston pressure accumulator, and partly with reference to a correspondingly designed piston pressure accumulator. A person skilled in the art will recognize that the features can be combined with one another and/or interchanged in a suitable manner in order to arrive at further embodiments of the invention and possibly to achieve synergy effects.

### BRIEF DESCRIPTION OF THE DRAWINGS

Embodiments of the invention will be described below with reference to the appended drawings. Neither the description nor the drawings are intended to be interpreted as restricting the invention.

FIG. 1 shows a sectional side view through a piston pressure accumulator according to one embodiment of the present invention; and

FIG. 2 shows a cross-sectional view through a piston pressure accumulator according to one embodiment of the present invention.

The figures are merely schematic and not true-to-scale.

### DETAILED DESCRIPTION

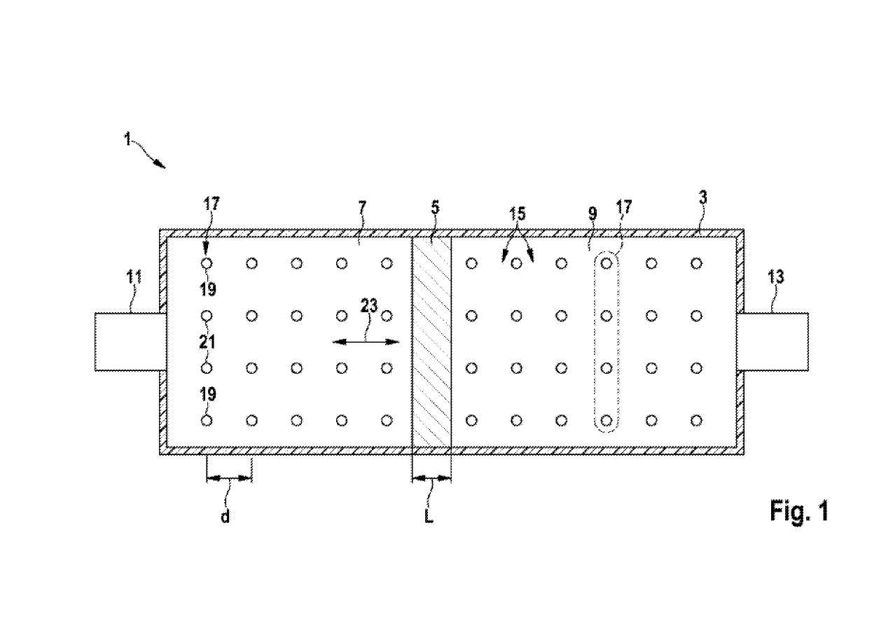

FIG. 1 shows a piston pressure accumulator 1 according to one embodiment of the present invention. The piston pressure accumulator 1 has a housing 3 of lightweight design which is largely composed of carbon fiber-reinforced plastic (CFRP). Said CFRPs are substantially made up of electrically conductive carbon fibers and a non-conductive plastic matrix, for example in the form of an artificial resin. The housing can have, for example, a cylindrical geometry with a diameter of, for example, 10-30 cm and a length of, for example, 50-300 cm.

A piston 5 which is composed of a likewise electrically conductive material, such as a metal, for example aluminum, for example, is arranged within the housing 3. The piston 5 serves as a separation element between two partial volumes 7, 9 within the housing 3 and seals off said partial volumes from one another. In this case, the piston 5 can be moved along a movement direction 23, which corresponds to the center axis of the cylinder of the housing 3, with the result that the partial volumes 7, 9 can be varied.

A non-compressible fluid, such as a liquid, in particular oil, for example, can be introduced into or discharged from a first partial volume 7 by means of a valve system 11, for example. A compressible fluid, such as a gas for example, can be introduced into or discharged from the other partial volume 9 by means of a valve system 13. In this case, the piston 5 can be moved along the movement direction 23 depending on the quantity of non-compressible fluid which is introduced into the partial volume 7, and can store mechanical energy by building up a pressure in the compressible fluid which is contained in the second partial volume 9.

On account of the electrical conductivity of the material which is used for the housing 3, a method for determining the position of the piston 5 within the closed housing 3 can be realized by determining the electrical resistance or the impedance at defined points on the housing 3, and a method for determining or checking a state of charge of the piston pressure accumulator 1 can be realized on the basis of said information. In this case, use is made of the fact that the electrical resistance or the electrical potential along the housing 3 differs depending on whether the piston 5 is in the respective measurement position or not.

In this case, the proposed method resembles that of electrical resistance tomography or electrical impedance tomography, as is used in geophysics, in order to obtain information relating to a condition of layers in a substrate, for example, by means of electrical voltage measurements between individual electrodes.

To this end, an electrode arrangement 15 is provided along a surface of the housing 3, said electrode arrangement being designed to allow a position of the piston to be determined by measuring a distribution of the electrical potential along the housing 3. In order to determine said electrical potential which is established or the electrical resistance which causes a potential distribution of this kind along the housing of the piston pressure accumulator, the electrode arrangement 15 can in this case have one or a plurality of 4-point measurement electrode pairs 17.

In this case, each 4-point measurement electrode pair 17 has two outer electrodes 19 by means of which a current with an intensity I can be induced in the conductive housing 3. On account of this current I, a distribution of an electrical potential is formed between the outer electrodes 19, said distribution being dependent on the locally prevailing electrical resistance as is caused by the housing 3 itself and also, possibly, by an electrically conductive piston 5 which adjoins said housing.

Two further inner electrodes 21 are provided between the outer electrodes 19, it being possible for a potential difference ΔU to be measured using said inner electrodes.

The outer electrodes 19 and the inner electrodes 21 of a 4-point measurement electrode pair 17 can, as illustrated in FIG. 1, be arranged along a line which extends transverse, preferably perpendicular, to the movement direction 23 of the piston 5. A distance s between adjacent 4-point measurement electrode pairs 17 can in this case preferably be selected to be smaller than or equal to a length L of the piston 5 in the direction parallel to the movement direction 23. In this case, the piston 5 adjoins one of the 4-point measurement electrode pairs 17 which is provided on the housing 3 for each position which it can assume within the housing 3. Therefore, during operation of the piston pressure accumulator 1, a potential difference which is established between the inner electrodes 21 can in each case be measured at all 4-point measurement electrode pairs 17 and therefore a distribution of the electrical potential along the housing 3 can be determined. Depending on the condition of, for example, the interior of the housing 3, this produces a specific potential difference which is correlated to the presence or absence of the piston 5. Therefore, the piston position can be discretely determined using a plurality of 4-point measurement electrode pairs 17 which are distributed over the length of the housing 3.

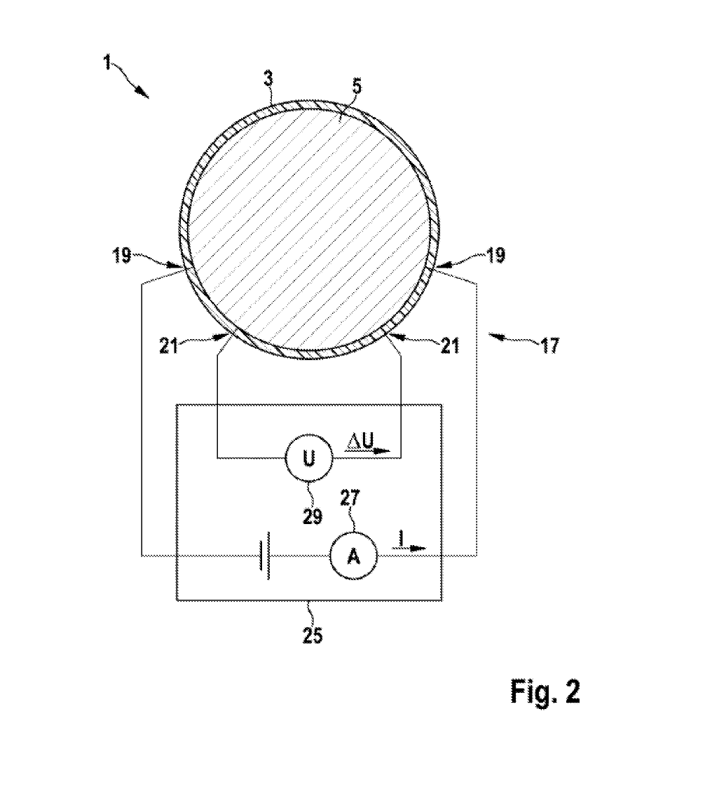

As illustrated in FIG. 2, an external monitoring apparatus 25 has both a controllable current source 27 and also a voltage measurement apparatus 29. The current source 27 is electrically connected to the outer electrodes 19. The voltage measurement apparatus 29 is connected to the inner electrodes 21. A resistance-dependent potential distribution is established within the housing 3 by applying a predefinable current I from the current source 27, across the outer electrodes 19, to the housing 3. A potential difference between two inner electrodes 21 can be determined with the aid of the voltage measurement apparatus 29.

The information which can be obtained with the aid of the described method relating to a current position of the piston 5 within the housing 3 can be used, amongst other things, to directly determine the SOC from the measured piston position, or else to initialize a calculation model for calculating the current state of charge of the piston pressure accumulator 1 from the measurement variables pressure and temperature and/or to compensate and to correct said calculation model during operation. As a result, a considerably higher degree of accuracy of the calculated state of charge value can be achieved, in particular under dynamic operating conditions.

1. A method for determining a position of a piston (5) within a piston pressure accumulator (1), wherein the piston pressure accumulator (1) has a housing (3) and a piston (5) which can be moved within the housing (3), characterized in that the method comprises:
determining the position of the piston (5) by measuring a distribution of the electrical resistance along the housing (3).

2. The method as claimed in claim 1, wherein an electric current (I) is locally induced in one or more positions in a region of the housing (3), and a resulting electrical potential distribution (ΔU) is locally determined.

3. The method as claimed in claim 2, wherein electric alternating current is locally induced in one or more positions in the region of the housing (3), and a resulting time-dependent electrical potential distribution is locally determined.

4. A method for determining or checking an item of information relating to a state of charge of a piston pressure accumulator (1),
characterized in that the method comprises the following steps:
determining a position of a piston (5) within the piston pressure accumulator (1) in accordance with a method as claimed in claim 1, and
determining the information relating to the state of charge of the piston pressure accumulator (1) taking into account the determined position of the piston (5).

5. A monitoring apparatus (25) for monitoring a piston pressure accumulator (1), characterized in that the monitoring apparatus (25) is configured to carry out a method as claimed in claim 1.

6. A piston pressure accumulator (1) having:
a housing (3), and
a piston (5) which can be moved within the housing (3),
characterized in that
an electrode arrangement (15) is provided on the housing (3), said electrode arrangement being designed to allow a position of a piston (5) to be determined by measuring a distribution of an electrical resistance along the housing (3).

7. The piston pressure accumulator as claimed in claim 6, wherein the housing (3) is formed from a fiber composite material.

8. The piston pressure accumulator as claimed in claim 7, wherein the electrode arrangement (15) is integrated into the fiber composite material.

9. The piston pressure accumulator as claimed in claim 6, wherein the electrode arrangement (15) has one or a plurality of 4-point measurement electrode pairs (17) which are arranged along a line parallel to a movement direction (23) of the piston (5) on the housing (3).

10. The piston pressure accumulator as claimed in claim 9, wherein a distance (s) between the 4-point measurement electrode pairs (17) which are adjacent parallel to the movement direction (23) of the piston (5) is smaller than a length (L) of the piston (5) in a direction parallel to said movement direction (23).

11. The method as claimed in claim 4, further comprising checking the information relating to the state of charge of the piston pressure accumulator (1) taking into account the determined position of the piston (5).

12. A method for determining or checking an item of information relating to a state of charge of a piston pressure accumulator (1),
characterized in that the method comprises the following steps:
determining a position of a piston (5) within the piston pressure accumulator (1) in accordance with a method as claimed in claim 1, and
checking the information relating to the state of charge of the piston pressure accumulator (1) taking into account the determined position of the piston (5).
